(19) United States
(12) Patent Application Publication
(10) Pub. No.: US 2011/0036216 A1
(43) Pub. Date: Feb. 17, 2011

(54) System for color coding tools to indicate the direction of operation, and said tools

(76) Inventors: Richard W. Cobbs, Glen Allen, VA (US); Patrick C. Cobbs, Philadelphia, PA (US)

Correspondence Address: Patrick Cabell Cobbs, 27 West Nippon St., Philadelphia, PA, 19119, US

(21) Appl. No.: 12/539,223

(22) Filed: Aug. 11, 2009

(51) Int. Cl. B25B 33/00; B23P 17/00

(52) U.S. Cl. 81/488; 29/284

(57) ABSTRACT

A system for marking rotationally operated tools to indicate direction. Said tools incorporate green indicia to indicate clockwise motion and/or tightening of right hand threaded implements, i.e. nuts, bolts, screws, drill bits, pipes, fasteners, fittings, etc. and red indicia to indicate counterclockwise motion and/or loosening of right hand threaded fasteners fittings and other spirally operated implements. Also a tool marked as previously indicated.

### BACKGROUND OF INVENTION

1. Field of Invention

This invention relates to rotationally operated tools, specifically to a means of color coding said tools to indicate proper direction or mode of operation. Many tools are designed to be used in a manner in which the orientation of the tool determines the preferred direction of use, although it may be used in either direction. The open end wrench has more substance, or material, on the side that should be subjected to the most force, or stress, and is designed to be used in a manner, or direction, that takes advantage of this extra reinforcement. This is common to many tools, i.e. vice grips, slip joint pliers, crescent wrenches. Some tools can not readily be used in both directions and must be turned over, or reversed, to change from clockwise to counterclockwise mode, such as strap wrenches and basin wrenches.

2. Description of Prior Art

99% of screws, nuts, bolts, fittings, etc. utilize right hand threads and must be installed with a clockwise motion and removed with a counterclockwise motion.

In the past, reversible ratchet wrenches have been marked with on and off, as described in U.S. Pat. No. 5,495,783; left and right, as in U.S. Pat. No. 6,138,532; cw and ccw, as in U.S. Pat. No. 3,337,014, to indicate installation or removal of right hand threaded mechanical fasteners, pipes, and other implements. It is not clear why these indicia are seldom used today. In an age of digital clocks some people don't know what clockwise and counterclockwise mean. Left and right also may be hard for the lay person to understand. So possibly these indicia were misunderstood or easily obscured with grime.

### SUMMARY

If the tool provided easy instruction, persons unfamiliar with the tool would be able to utilize it properly, and even those familiar with the tool may be able to use it more easily.

By incorporating an easily seen colored arrow, dot, sectional color impregnation, appliqué, or other means, the proper orientation could readily be determined. Simply put: green would mean tighten and red would mean loosen. If one wishes to tighten a bolt, nut, etc. expose the green mark and use as indicated or designed. If one wishes to loosen a bolt, nut, etc. expose red mark and use as indicated or designed.

Thus the purpose of the present invention is to provide an easy to use system which enables proper usage of various tools in a timely and almost intuitive manner.

The present invention provides a means of color coding rotationally operated tools wherein green=tighten=clockwise; and red=loosen=counterclockwise.

An embodiment of the invention includes a ratchet wrench wherein the directional lever placement for clockwise operation reveals a green marking and said directional lever placement for counterclockwise operation reveals a red mark.

A further embodiment of the invention relates to open end wrenches wherein a green arrow or other mark denotes how to tighten, and a red arrow or other mark denotes how to loosen.

On a reversible drill the green mark is exposed to perform a drilling operation and the red mark is exposed to unclog or back out the drill bit.

On offset pliers, the green side of the tool indicates tightening of right hand threaded objects and the red side indicates loosening of right hand threaded objects.

There are numerous other embodiments, i.e. pipe wrenches, basin wrenches,strap wrenches, and in addition to these embodiments, persons skilled in the art can see that numerous modifications and changes may be made to the invention without departing from the intended spirit and scope thereof.

### OBJECTS AND ADVANTAGES OF THE PRESENT INVENTION

1. To provide an easily understood indication of the directional mode of a tool.

2. To provide a highly visible indicium for marking the operational direction of a tool.

3. To establish green as an indicator meaning installation or tightening of a right hand threaded implement, or the proper orientation of a tool to accomplish said installation: also to establish red as an indicator of removal or loosening of a right hand threaded implement or the proper orientation of a tool to accomplish said removal, loosening, withdrawal, etc.

4. To work with many tools: wrenches, drills, power screwdrivers, ratchet wrenches, etc.

### DESCRIPTION OF THE DRAWINGS

FIG. 1. Illustrates an open end wrench wherein the green arrow denotes how to tighten.

FIG. 2. Illustrates the other side of the wrench in FIG. 1; on this side the arrow is red and indicates how to loosen a right hand threaded implement by turning said implement in a counterclockwise direction.

FIG. 3. On a ratchet wrench, the switch lever exposes a green mark to denote tightening mode.

FIG. 4. On a basin wrench exposure of the red side denotes loosening

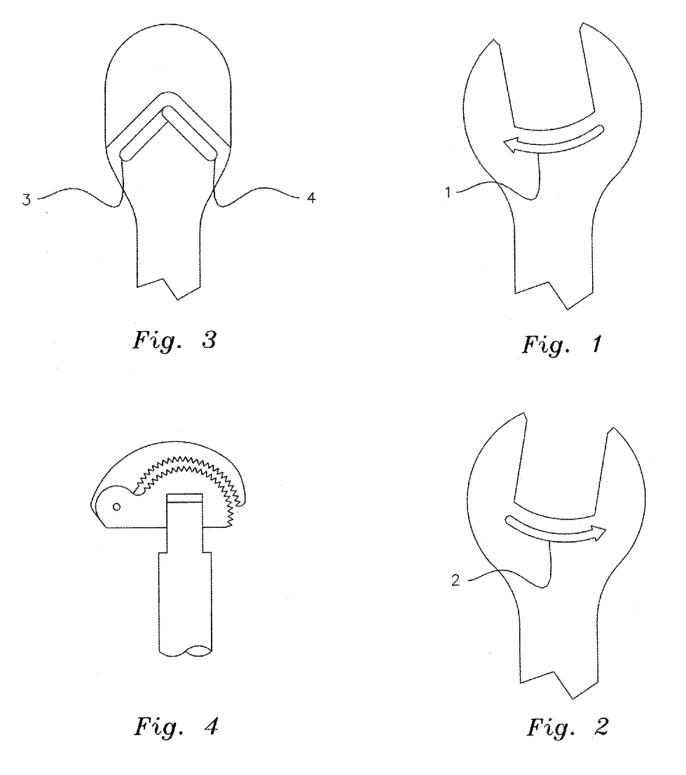

I claim:

1. A system for marking a rotationally operated tool with a green indicium to denote clockwise and red indicium to denote counterclockwise rotation.

2. A tool with colored indicia to indicate direction of operation wherein green means clockwise and red means counterclockwise.
